(19) United States
(12) Patent Application Publication
(10) Pub. No.: US 2025/0364625 A1
(43) Pub. Date: Nov. 27, 2025

(54) PLATE AND BATTERY CELL STACK INCLUDING THE SAME

(71) Applicants: Hyundai Motor Company, Seoul (KR); Kia Corporation, Seoul (KR)

(72) Inventors: Jong Gyu Park, Hwaseong-si (KR); Kyung Mo Kim, Hwaseong-si (KR); Gun Woo Ko, Hwaseong-si (KR); Chan Sol Kim, Hwaseong-si (KR)

(21) Appl. No.: 18/955,352

(22) Filed: Nov. 21, 2024

(30) Foreign Application Priority Data
May 24, 2024 (KR) 10-2024-0068050

(51) Int. Cl. H01M 10/6555; H01M 10/613; H01M 10/647

(52) U.S. Cl. CPC H01M 10/6555; H01M 10/613; H01M 10/647

(57) ABSTRACT

A battery cell stack can include a plurality of battery cells extending in a first direction, and arranged in a second direction crossing the first direction, and a plate device disposed between the plurality of battery cells. The plate device can include a first plate and a second plate, where the second plate is disposed parallel to the first plate, and where the second plate is configured to be coupled to the first plate on one side of the plurality of battery cells.

### CROSS-REFERENCE TO RELATED APPLICATIONS

This application claims the benefit of priority to Korean Patent Application No. 10-2024-0068050, filed in the Korean Intellectual Property Office on May 24, 2024, the entire contents of which are incorporated herein by reference.

### TECHNICAL FIELD

The present disclosure relates to a battery cell stack.

### BACKGROUND

Recently, as awareness of the crisis regarding the environment and depletion of petroleum resources has increased, research and development on electric vehicles that are eco-friendly vehicles has been highlighted. Electric vehicles include a plug-in hybrid electric vehicle (PHEV), a battery electric vehicle (BEV), and a fuel cell electric vehicle (FCEV).

An electric vehicle may include a battery housing that supports battery cells. An electric vehicle uses battery cells as a power source, and efforts have been made recently to increase the capacity of battery cells accommodated in an interior of the battery housing.

To improve the capacity of battery cells, battery cells may be accommodated in the interior of the battery housing in the form of cell to pack (CTP) rather than in the form of modules. Meanwhile, the need for a battery cell stack that prevents swelling of battery cells accommodated in the form of a CTP in a battery housing is increasing.

### SUMMARY

The present disclosure relates to a plate, and a battery cell stack including the same.

An embodiment of the present disclosure can solve the above-mentioned problems occurring in the prior art while advantages achieved by the prior art are maintained intact.

An embodiment of the present disclosure can provide a plate device that prevents swelling of battery cells accommodated in a battery housing, and a battery cell stack including the same.

Technical problems to be solved by an embodiment of the present disclosure are not necessarily limited to the aforementioned problems, and solutions to other technical problems not mentioned herein by an embodiment of the present disclosure can be understood from the following description by those skilled in the art to which the present disclosure pertains.

According to an embodiment of the present disclosure, a battery cell stack can include a plurality of battery cells, and each of the plurality of battery cells extends along a first direction, and the plurality of battery cells are arranged and distributed in a second direction, and the second direction crosses the first direction, and a plate device disposed between the plurality of battery cells. The plate device includes a first plate, and a second plate disposed parallel to the first plate. The second plate can be configured to be coupled to the first plate at a first end of the plurality of battery cells, and a first battery cell of the plurality of battery cells is disposed between the first plate and the second plate, and a second battery cell of the plurality of batter cells is disposed outside of the first plate, and wherein a third battery cell of the plurality of battery cells is disposed outside of the second plate.

The plate device may include a cooling plate that cools the plurality of battery cells.

The first plate may include a first body part disposed between the first battery cell and the second battery cell of the plurality of battery cells, and a first-plate first end side part extending from the first body part in the second direction at the first end of the plurality of battery cells, the second plate may include a second body part disposed between the first battery cell and the third battery cell of the plurality of battery cells. The second body part may be disposed in parallel to the first body part, and a second-plate first-end side part extending from the second body part in the second direction at the first end of the plurality of the battery cells in the first direction, and the first-plate first-end side part may be configured to be interlocked with the second-plate first-end side part.

The second-plate first-end side part may include a first side hole, and the first-plate first-end side may include a first locking boss configured to be inserted into the first side hole.

The first locking boss may include a first base area protruding from the first-plate first-end side part. The first base area may be configured to be inserted into the first side hole, and a first locking area protruding from the first base area, and extending in the second direction.

The first-plate first-end side part may be disposed on a first face of the second-plate first-end side part, and the first locking boss may protrude from the first-plate first-end side part through the first side hole toward a second face of the second-plate first-end side part. The second face may be opposite to the first face.

The first plate may include a first-plate second-end side part extending in a third direction from the first body part, a second end of the plurality of battery cells. The second end may be opposite to the first end and the third direction may be parallel with the second direction. The second plate may include a second-plate second-end side part extending in the third direction from the second body part at the second end of the plurality of battery cells, and the first-plate second-end side part may be configured to be interlocked with the second-plate second-end side part.

The second-plate second-end side part may include a second side hole, and the first-plate second-end side part may include a second locking boss configured to be inserted into the second side hole.

The second locking boss may include a second base area protruding from the second-plate second-end side part, and the second base area may be configured to be inserted into the second side hole, and a second locking area protruding from the second base area, and extending in the third direction.

The first-plate second-end side part may be disposed on a first face of the second-plate second-end side part, and the second locking boss may protrude from first-plate second-end side part through the second side hole toward a second face of the second-plate second-end side part and the second face may be opposite to the first direction.

The first-plate first-end side part and the second-plate first-end side part may be bent from the first body part and the second body part, respectively, toward in the second direction, and the first-plate second-end side part and the second-plate second-end side part may be bent from the first body part and the second body part, respectively, toward the third direction. The second direction may be facing opposite relative to the third direction.

A first length, by which the first-plate first-end side part extends from the first body part, may be configured to be greater than a second length, by which the second-plate first-end side part extends from the second body part.

A first length, by which the first-plate second-end side part extends from the first body part, may be configured to be smaller than a second length, by which the second-plate second-end side part extends from the second body part.

A maximum displacement of the first-plate first-end side part and the second-plate first-end side part in the second direction may be configured to be greater than or equal to a value obtained by multiplying a number of battery components provided between the first plate and the second plate and a minimum thickness of each of the battery components in the second direction.

A maximum displacement of the first-plate first-end side part and the second-plate first-end side part in the second direction may be configured to be smaller than or equal to a value obtained by multiplying a number of the battery components provided between the first plate and the second plate and a maximum thickness of each of the battery components in the second direction.

According to an embodiment of the present disclosure, a plate device for a battery cell stack includes a first plate including a first body part extending in a first direction, and a first-plate first-end side part extending from the first body part in a second direction and the second direction crosses the first direction, and a second plate including a second body part extending in the first direction and disposed parallel to the first body part, and a second-plate first-end side part extending from the second body part in the second direction. The first-plate first-end side part is configured to be coupled to the second-plate first-end side part.

The second-plate first-end side part may include a first side hole, and the first-plate first-end side part may include a first locking boss configured to be inserted into the first side hole.

The first locking boss may include a first base area protruding from the first-plate first-end side part, and the first base area may be configured to be inserted into the first side hole, and a first locking area protruding from the first base area, and extending in the second direction.

The first plate may include a first-plate second-end side part extending from the first body part at an opposite end of the first body part relative to the first-plate second-end side part, and extending to an opposite side in the second direction. The second plate may include a second-plate second-end side part extending from the second body part at the opposite end of the second body part relative to the second-plate first-end part, and extending to the opposite side in the second direction, and the first-plate second-end side part may be configured to be locked by the second-plate second-end side part.

The second-plate second-end side part may include a second side hole, and the first-plate second-end side part may include a second locking boss configured to be inserted into the second side hole.

### BRIEF DESCRIPTION OF THE DRAWINGS

The above and other features and advantages of an embodiment of the present disclosure will be more apparent from the following detailed description taken in conjunction with the accompanying drawings, in which:

FIG. 1 is an exploded perspective view of a battery pack according to an embodiment of the present disclosure.

FIG. 2 is a perspective view of a battery housing and a battery cell stack according to an embodiment of the present disclosure.

FIG. 3 is a vertical cross-sectional view of a battery housing and a battery cell stack according to an embodiment of the present disclosure.

FIG. 4 is a perspective view of a battery cell stack and peripheral components according to an embodiment of the present disclosure.

FIG. 5 is a perspective view of a plate according to an embodiment of the present disclosure.

FIG. 6 is a perspective view of a second plate according to an embodiment of the present disclosure.

FIG. 7 is a perspective view of a first plate according to an embodiment of the present disclosure.

FIG. 8 is a horizontal cross-sectional view of a battery cell stack and a side member according to an embodiment of the present disclosure.

FIG. 9 is a vertical cross-sectional view of a battery cell stack and a cross member according to an embodiment of the present disclosure.

### DETAILED DESCRIPTION OF ILLUSTRATIVE EMBODIMENTS

Hereinafter, example embodiments of the present disclosure will be described in detail with reference to the accompanying drawings. In adding reference numerals to the components of the drawings, same components can be denoted by same reference numerals even when they are shown in different drawings. Furthermore, in describing the example embodiments of the present disclosure, when it is determined that a detailed description of related known configurations and functions may hinder understanding of the example embodiments of the present disclosure, a detailed description thereof can be omitted.

Furthermore, in describing the components of the embodiments of the present disclosure, terms, such as “first,” “second,” “A”, “B”, “(a),” and “(b)” may be used. Such terms can be used simply for distinguishing the components, and the essence, the sequence, and the order of the corresponding components are not necessarily limited by such terms. Unless otherwise defined, terms, including technical and scientific terms, used herein can have a same meaning as commonly understood by those skilled in the art to which the present disclosure pertains. It can be further understood that terms, such as those defined in commonly used dictionaries, can be interpreted as having a meaning that is consistent with their meaning in the context of the specification and relevant art and should not be interpreted in an idealized or overly formal sense unless expressly so defined herein.

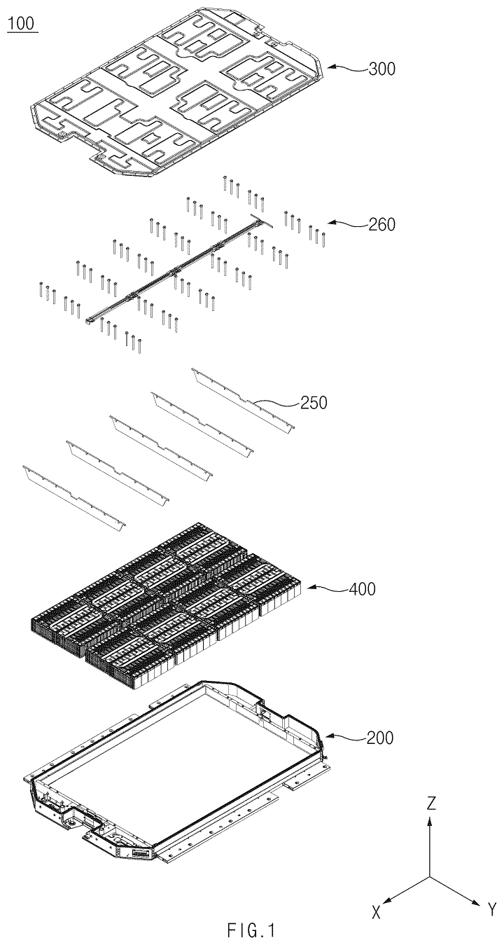

Hereinafter, example embodiments of the present disclosure will be described in detail with reference to FIGS. 1 to 9. Hereinafter, a leftward/rightward direction may be a first direction, a forward/rearward direction may be a second direction, and an upward/downward direction may be a third direction.

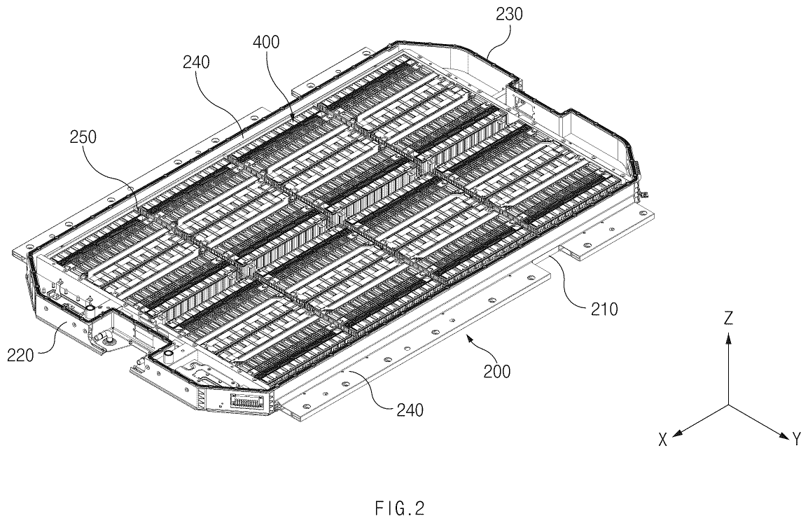

FIG. 1 is an exploded perspective view of a battery pack according to an embodiment of the present disclosure. FIG. 2 is a perspective view of a battery housing and a battery cell stack according to an embodiment of the present disclosure.

Referring to FIGS. 1 and 2, a battery pack 100 may include a battery housing 200, and a pack cover 300 that is disposed on an upper side (the “Z” direction) of the battery housing 200. The battery pack 100 may include a battery cell stack 400 that is accommodated in an interior of the battery housing 200. The pack cover 300 may be coupled to or contact the battery housing 200 to cover an upper side of the battery cell stack 400.

The battery housing 200 may define a space, in which the battery cell stack 400 is accommodated. The battery housing 200 may include a base plate 210 that supports the battery cell stack 400, a front member 220 that is supported by the base plate 210 and covers a front (the “X” direction) area of the battery cell stack 400, and a rear member 230 that covers a rear (an opposite direction to the “X” direction) area of the battery cell stack 400.

The battery housing 200 may include a side member 240 that is disposed in a leftward/rightward direction of the base plate 210 and is supported by the base plate 210. A pair of side members 240 may be provided, and may be provided opposite sides of the battery cell stack 400 in the leftward/rightward direction, respectively. Each of the pair of side members 240 may cover an opposite side area of the battery cell stack 400 in the leftward/rightward direction.

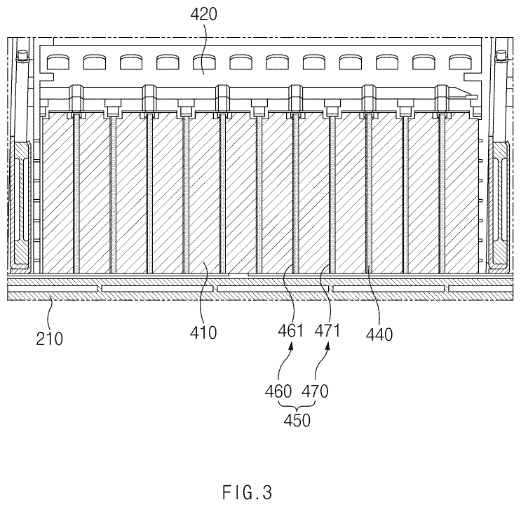

The battery cell stack 400 may include a plurality of battery cells 410 (see FIG. 3). The plurality of battery cells 410 may be accommodated in the battery housing 200 with no separate module frame.

That is, the battery cell 410 according to an embodiment of the present disclosure may be mounted in an interior of the battery pack 100 in the form of a cell-to-pack (CTP). However, the method of mounting the battery cells 410 on the battery pack 100 is not necessarily limited thereto, and the battery cells 410 may be provided with a separate module frame to be accommodated in the battery housing 200.

The battery housing 200 may include a cross member 250 that is disposed between the front member 220 and the rear member 230. The cross member 250 may extend in a leftward/rightward direction (the “Y” direction or an opposite direction to the “Y” direction) between the front member 220 and the rear member 230. The cross member 250 may support a pair of battery cell stacks 400 that are disposed between the plurality of battery cell stacks 400 and are disposed parallel to each other with the cross member 250 being interposed therebetween.

The battery pack 100 may include a fixing member 260 that is configured to fix the cross member 250 to the battery housing 200.

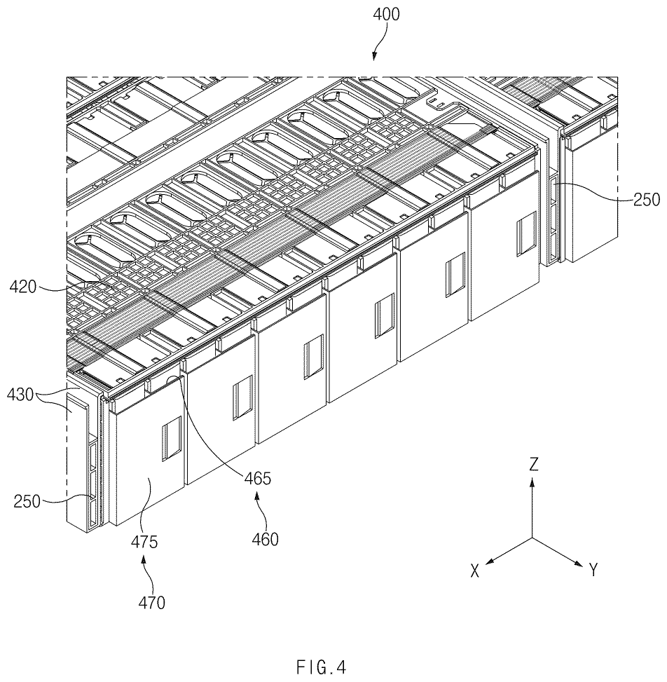

FIG. 3 is a vertical cross-sectional view of a battery housing and a battery cell stack according to an embodiment of the present disclosure. FIG. 4 is a perspective view of a battery cell stack and peripheral components according to an embodiment of the present disclosure.

Referring to FIGS. 3 and 4, the battery cell stack 400 may include a plurality of battery cells 410 that are supported by the base plate 210, and extend in the first direction that is the leftward/rightward direction, and are arranged in the second direction that is the forward/rearward direction. In this example, the first direction and the second direction may be perpendicular to each other. The battery cells 410 may be an angular or cylindrical battery cell or a pouch type battery cell.

The battery cell stack 400 may include a sensing assembly 420 that is disposed on an upper side of the plurality of battery cells 410, and end plates 430 that are disposed on opposite sides of the plurality of battery cells 410 in the forward/rearward direction. The sensing assembly 420 may be electrically connected to the battery cells 410. The end plates 430 may be disposed on opposite sides of the battery cell stack 400 that are stacked in forward/rearward direction. The pair of end plates 430 may press the plurality of battery cells 410 on opposite sides of the plurality of battery cells 410.

The battery cell stack 400 may include a surface-pressure member 440 and a plate device 450 that are disposed between the plurality of battery cells 410, respectively. The surface-pressure member 440 may be a component for preventing swelling of the battery cells 410 by pressing the battery cells 410 that do not directly contact the end plates 430.

At least a portion of the plate device 450 may be disposed between the battery cells 410 to cool the battery cells 410. The plate device 450 may contact the battery cells 410. The plate device 450 may be provided as a cooling plate for cooling the battery cells 410 while contacting the battery cells 410.

The plate device 450 may include a first plate 460, and a second plate 470 that is disposed parallel to the first plate 460 and is configured to be coupled to the first plate 460 on opposition sides of the battery cells 410 in the leftward/rightward direction.

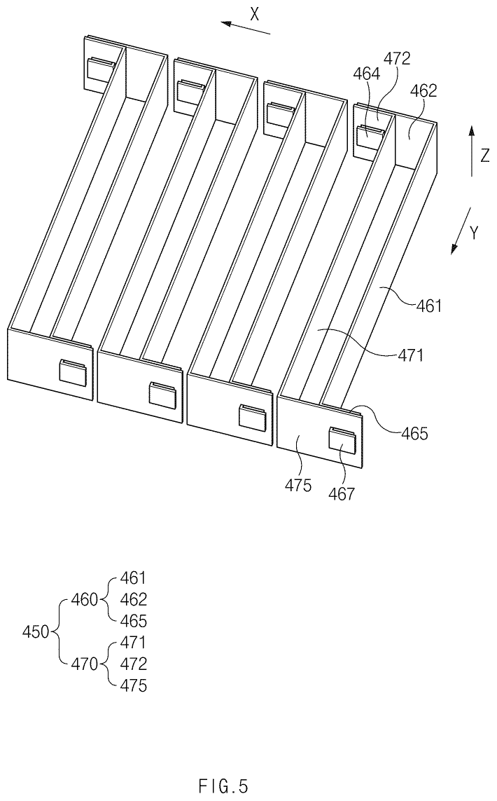

The first plate 460 may include a first body part 461 that is disposed between the plurality of battery cells 410, and (1-1)-th and (1-2)-th side parts 462 and 465 (see FIG. 5) that are connected to the first body part 461 and are disposed on opposite sides of the first body part 461 in the leftward/rightward direction.

The second plate 470 may include a second body part 471 that is disposed between the battery cells 410, and (2-1)-th and (2-2)-th side parts 472 and 475 that are connected to the second body part 471 and are disposed on opposite sides of the second body part 471 in the leftward/rightward direction.

The first-plate first-end side part 462 and the second-plate first-end side part 472 may be coupled to each other, and the first-plate second-end side part 465 and the second-plate second-end side part 475 may be coupled to each other. In more detail, the first-plate first-end side part 462 may be configured to be locked by the second-plate first-end side part 472, and the first-plate second-end side part 465 may be configured to be locked by the second-plate second-end side part 475.

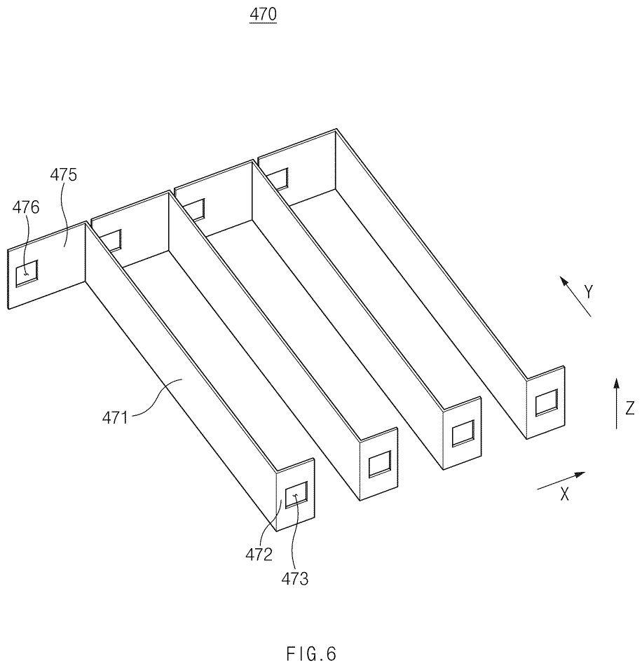

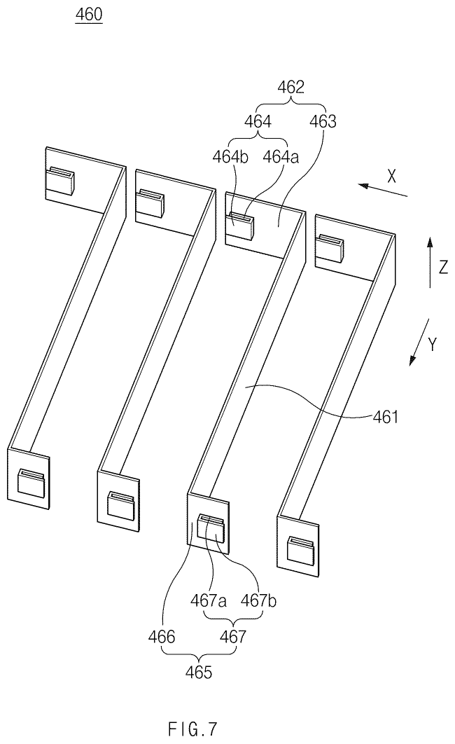

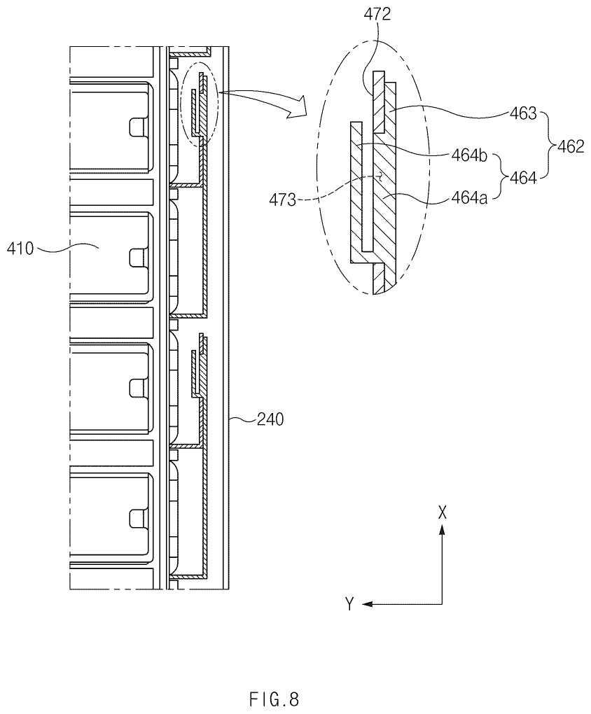

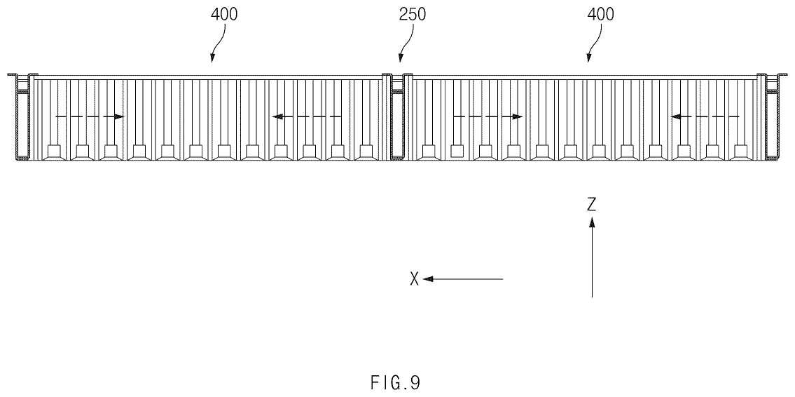

FIG. 5 is a perspective view of a plate according to an embodiment of the present disclosure. FIG. 6 is a perspective view of a second plate according to an embodiment of the present disclosure. FIG. 7 is a perspective view of a first plate according to an embodiment of the present disclosure. FIG. 8 is a horizontal cross-sectional view of a battery cell stack and a side member according to an embodiment of the present disclosure. FIG. 9 is a vertical cross-sectional view of a battery cell stack and a cross member according to an embodiment of the present disclosure.

Referring to FIGS. 5 to 9, the first-plate first-end side part 462 may extend from the first body part 461 and may be disposed on a right side of the battery cells 410, and the first-plate second-end side part 465 may extend from the first body part 461 and may be disposed on a left side of the battery cells 410. Here, the right side may be one side in the first direction, and the left side may be an opposite side in the first direction.

The first body part 461 may extend in the leftward/rightward direction, and the first-plate first-end side part 462 may extend forward from one end of the first body part 461 in the leftward/rightward direction. Furthermore, the first-plate second-end side part 465 may extend rearward from the first body part 461 on an opposite side to one side, on which the first-plate first-end side part 462 of the first body part 461 is provided. In other words, the first-plate second-end side part 465 may extend rearward from the opposite end of the first body part 461 in the leftward/rightward direction. Here, the term “the front side” may be one side in the second direction, and the term “the rear side” may be an opposite side in the second direction.

The second-plate first-end side part 472 may extend from the second body part 471 and may be disposed on the right side of the battery cells 410, and the second-plate second-end side part 475 may extend from the second body part 471 and may be disposed on the left side of the battery cells 410.

The second body part 471 may be disposed parallel to the first body part 461, and the second-plate first-end side part 472 may extend forward from one end of the second body part 471 in the leftward/rightward direction. Furthermore, the second-plate second-end side part 475 may extend rearward from the second body part 471 on an opposite side to one side, on which the second-plate first-end side part 472 of the second body part 471 is provided. In other words, the second-plate second-end side part 475 may extend rearward from the opposite end of the second body part 471 in the leftward/rightward direction.

Each of the side part 462 and the second-plate first-end side part 472 may be bent forward from the first body part 461 or the second body part 471. Each of the first-plate second-end side part 465 and the second-plate second-end side part 475 may be bent rearward from the first body part 461 or the second body part 471.

A length, by which the side part 462 extends forward from the first body part 461, may be greater than a length, by which the second-plate first-end side part 472 extends forward from the second body part 471.

On the contrary, a length, by which the first-plate second-end side part 465 extends rearward from the first body part 461, may be smaller than a length, by which the second-plate second-end side part 475 extends rearward from the second body part 471.

The side part 472 may include a first side hole 473, and the second-plate second-end side part 475 may include a second side hole 476.

The side part 462 may include a first locking boss 464 that is configured to be inserted into the first side hole 473, and the first-plate second-end side part 465 may include a second locking boss 467 that is configured to be inserted into the second side hole 476.

In more detail, the first-plate first-end side part 462 may include a first cover area 463 that is disposed parallel to the second-plate first-end side part 472 on the right side of the second-plate first-end side part 472, and a first locking boss 464 that protrudes from the first cover area 463 toward the second-plate first-end side part 472. That is, the first locking boss 464 may protrude leftward from the first cover area 463.

The side part 465 may include a second cover area 466 that is disposed parallel to the second-plate second-end side part 475 on the right side of the second-plate second-end side part 475, and a second locking boss 467 that protrudes from the second cover area 466 toward the second-plate second-end side part 475. That is, the second locking boss 467 may protrude leftward from the second cover area 466.

The first locking boss 464 may include a first base area 464a that protrudes from the first cover area 463 and is inserted into the first side hole 473, and a first locking area 464b that protrudes from the first base area 464a toward the battery cells 410 and extends forward.

The first locking area 464b may include one end that is connected to the first base area 464a and an opposite end that protrudes leftward from the one end and extends forward. According to this structure, a second-plate first-end side part 472 may be provided between the first locking area 464b and the first base area 464a.

Therefore, even when the battery cells 410 provided between the first plate 460 and the second plate 470 are swollen, the first-plate first-end side part 462 and the second-plate first-end side part 472 may be prevented from being decoupled on the one side of the battery cell 410 in the leftward/rightward direction.

Similarly, the second locking boss 467 may include a second base area 467a that protrudes from the second cover area 466 and is inserted into the second side hole 476 and a second locking area 467b that protrudes from the second base area 467a in the opposite direction of the battery cell 410 and extends rearward.

The second locking area 467b may include one end that is connected to the second base area 467a and an opposite end that protrudes leftward from the one end and extends rearward. According to this structure, a second-plate second-end side part 475 may be provided between the second locking area 467b and the second base area 467a.

Therefore, even when the battery cells 410 provided between the first plate 460 and the second plate 470 are swollen, the first-plate second-end side part 465 and the second-plate second-end side part 475 may be prevented from being decoupled on an opposite side of the battery cell 410 in the leftward/rightward direction.

Furthermore, even when the battery cells 410 disposed on a front side of the second plate 470 are swollen, the second-plate first-end side part 472 and the second-plate second-end side part 475 of the second plate 470 may be prevented from being moved rearward, and the first-plate first-end side part 462 and the first-plate second-end side part 465 of the first plate 460 disposed on a front side of the second plate 470 may be prevented from being moved forward.

According to this structure, the first plate 460 and the second plate 470 may be coupled to each other in an opposite side area of the battery cells 410, and even when the battery cells 410 provided between the first plate 460 and the second plate 470 are swollen, the battery cells 410 may be pressed on the opposite sides in the forward/rearward direction. Therefore, because the swelling phenomenon of the battery cells 410 may be prevented, a performance of the battery cells 410 may be prevented from deteriorating.

The first plate 460 and the second plate 470 in the drawing may be coupled to each other on the right side of the battery cell 410 disposed on a front side of the second plate 470 or on the left side of the battery cell 410 disposed on a rear side of the first plate 460, but the present disclosure is not necessarily limited thereto, and may be coupled to each other on opposite sides of the battery cells 410 provided between the first plate 460 and the second plate 470 in the leftward/rightward direction.

One battery cell 410 may be provided between the first plate 460 and the second plate 470, but the present disclosure is not necessarily limited thereto, and a plurality of battery cells 410 may be provided.

A maximum displacement between the side part 462 and the second-plate first-end side part 472 in the forward/rearward direction may be configured to be greater than or equal to a multiplication of the number of battery cells 410 provided between the first plate 460 and the second plate 470 and a minimum thickness of the battery cell 410 in the forward/rearward direction.

Here, a maximum displacement between the first-plate first-end side part 462 and the second-plate first-end side part 472 in the forward/rearward direction may be a maximum displacement of the first-plate first-end side part 462 or the second-plate first-end side part 472 in the forward/rearward direction before the first locking boss 464 is locked by the second-plate first-end side part 472. Here, a minimum thickness of the battery cells 410 in the forward/rearward direction may be a thickness of the battery cells 410 in the forward/rearward direction before the battery cells 410 are operated.

Furthermore, a maximum displacement between the first-plate first-end side part 462 and the second-plate first-end side part 472 in the forward/rearward direction may be configured to be smaller than or equal to a multiplication of the number of battery cells 410 provided between the first plate 460 and the second plate 470 and a maximum thickness of the battery cell 410 in the forward/rearward direction.

Here, a maximum thickness of the battery cells 410 in the forward/rearward direction may be a thickness of the battery cells 410 in the forward/rearward direction when the battery cells 410 are swollen. In more detail, a thickness in the forward/rearward direction due to swelling of the battery cells 410 may be between 5 mm due to swelling at the initial use of the battery cells 410 and 1 mm due to swelling after the battery cells 410 are used for 15 years or 300,000 km.

The maximum displacement between the side part 462 and the second-plate first-end side part 472 in the forward/rearward direction may be the same as the maximum displacement between the first-plate second-end side part 465 and the second-plate second-end side part 475 in the forward/rearward direction.

Furthermore, a maximum displacement between the first plate 460 and the second plate 470 that contact the battery cell 410 that is swollen the most, among the battery stack 400 provided between the two cross members 250 spaced apart from each other in the forward/rearward direction, in the forward/rearward direction, and a maximum displacement between the first plate 460 and the second plate 470 that contact the battery cell 410 that is swollen the least, in the forward/rearward direction, may be adjusted differently.

For example, a maximum displacement between the first plate 460 and the second plate 470 that contact the battery cell 410 that is located in a middle area, among the battery cells 400 provided between the two cross members 250 spaced apart from each other in the forward/rearward direction, in the forward/rearward direction, may be greater than a maximum displacement between the first plate 460 and the second plate 470 that contact the battery cell 410 that are located in opposite side areas in the forward/rearward direction, in the forward/rearward direction.

An embodiment of the present disclosure may prevent swelling of the battery cells accommodated in the battery housing, and may improve a density of the battery cells and may improve a performance of the battery cells as well.

Various advantages that are directly or indirectly identified through this document may be provided.

Therefore, the example embodiments disclosed in the present disclosure are not for necessarily limiting the technical spirits of the present disclosure but for describing them, and the scopes of the technical spirits of the present disclosure are not necessarily limited by the example embodiments. The protection scopes of the present disclosure can be construed by the following claims, and technical spirits in the equivalent range can be construed as being included in the scopes of the present disclosure.

What is claimed is:

1. A battery cell stack comprising:
a plurality of battery cells, wherein each of the plurality of battery cells extends along a first direction, wherein the plurality of battery cells are arranged and distributed in a second direction, and wherein the second direction crosses the first direction; and
a plate device disposed between the plurality of battery cells, wherein the plate device comprises a first plate, and a second plate disposed parallel to the first plate, wherein the second plate is configured to be coupled to the first plate at a first end of the plurality of battery cells, wherein a first battery cell of the plurality of battery cells is disposed between the first plate and the second plate, wherein a second battery cell of the plurality of battery cells is disposed outside of the first plate, and wherein a third battery cell of the plurality of battery cells is disposed outside of the second plate.

2. The battery cell stack of claim 1, wherein the plate device includes a cooling plate configured to cool the plurality of battery cells.

3. The battery cell stack of claim 1, wherein the first plate comprises:
a first body part disposed between the first battery cell and the second battery cell of the plurality of battery cells, and a first-plate first-end side part extending from the first body part in the second direction at the first end of the plurality of battery cells; and
wherein the second plate comprises:
a second body part disposed between the first battery cell and the third battery cell of the plurality of battery cells, wherein the second body part is disposed in parallel to the first body part, and
a second-plate first-end side part extending from the second body part in the second direction at the first end of the plurality of the battery cells, wherein the first-plate first-end side part is configured to be interlocked with the second-plate first-end side part.

4. The battery cell stack of claim 3, wherein the second-plate first-end side part includes a first side hole, and wherein the first-plate first-end side part includes a first locking boss configured to be inserted into the first side hole.

5. The battery cell stack of claim 4, wherein the first locking boss comprises:
a first base area protruding from the first-plate first-end side part, wherein the first base area is configured to be inserted into the first side hole; and
a first locking area protruding from the first base area and extending in the second direction.

6. The battery cell stack of claim 5, wherein the first-plate first-end side part is disposed on a first face of the second-plate first-end side part, and wherein the first locking boss protrudes from the first-plate first-end side part through the first side hole toward a second face of the second-plate first-end side part, wherein the second face is opposite to the first face.

7. The battery cell stack of claim 3, wherein the first plate further includes a first-plate second-end side part extending in a third direction from the first body part at a second end of the plurality of battery cells, wherein the second end is opposite to the first end, wherein the third direction is parallel with the second direction,
wherein the second plate includes a second-plate second-end side part extending in the third direction from the second body part at the second end of the plurality of battery cells, and
wherein the first-plate second-end side part is configured to be interlocked with the second-plate second-end side part.

8. The battery cell stack of claim 7, wherein the second-plate second-end side part includes a second side hole, and
wherein the first-plate second-end side part includes a second locking boss configured to be inserted into the second side hole.

9. The battery cell stack of claim 8, wherein the second locking boss comprises:
a second base area protruding from the second-plate second-end side part, and wherein the second base area is configured to be inserted into the second side hole; and
a second locking area protruding from the second base area, and extending in the third direction.

10. The battery cell stack of claim 9, wherein the first-plate second-end side part is disposed on a first face of the second-plate second-end side part, and wherein the second locking boss protrudes from the first-plate second-end side part through the second side hole toward a second face of the second-plate second-end side part, wherein the second face is opposite to the first face.

11. The battery cell stack of claim 7, wherein the first-plate first-end side part and the second-plate first-end side part are bent from the first body part and the second body part, respectively, toward the second direction, and
wherein the first-plate second-end side part and the second-plate second-end side part are bent from the first body part and the second body part, respectively, toward the third direction, wherein the second direction is facing opposite relative to the third direction.

12. The battery cell stack of claim 3, wherein a first length, by which the first-plate first-end side part extends from the first body part, is configured to be greater than a second length, by which the second-plate first-end side part extends from the second body part.

13. The battery cell stack of claim 7, wherein a first length, by which the first-plate second-end side part extends from the first body part, is configured to be smaller than a second length, by which the second-plate second-end side part extends from the second body part.

14. The battery cell stack of claim 3, wherein a maximum displacement of the first-plate first-end side part and the second-plate first-end side part in the second direction is configured to be greater than or equal to a value obtained by multiplying a number of battery components provided between the first plate and the second plate and a minimum thickness of each of the battery components in the second direction.

15. The battery cell stack of claim 3, wherein a maximum displacement of the first-plate first-end side part and the second-plate first-end side part in the second direction is configured to be smaller than or equal to a value obtained by multiplying a number of battery components provided between the first plate and the second plate and a maximum thickness of each of the battery components in the second direction.

16. A plate device for a battery cell stack, the plate device comprising:
a first plate including:
a first body part extending in a first direction, and
a first-plate first-end side part extending from the first body part in a second direction, wherein the second direction crosses the first direction; and
a second plate including:
a second body part extending in the first direction and disposed parallel to the first body part, and
a second-plate first-end side part extending from the second body part in the second direction, wherein the first-plate first-end side part is configured to be coupled to the second-plate first-end side part.

17. The plate device of claim 16, wherein the second-plate first-end side part includes a first side hole, and
wherein the first-plate first-end side part includes a first locking boss configured to be inserted into the first side hole.

18. The plate device of claim 17, wherein the first locking boss comprises:
a first base area protruding from the first-plate first-end side part, and wherein the first base area is configured to be inserted into the first side hole; and
a first locking area protruding from the first base area and extending in the second direction.

19. The plate device of claim 16, wherein the first plate includes a first-plate second-end side part extending from the first body part at an opposite end of the first body part relative to the first-plate second-end side part, and extending to an opposite side in the second direction,
wherein the second plate includes a second-plate second-end side part extending from the second body part at the opposite end of the second body part relative to the second-plate first-end side part, and extending to the opposite side in the second direction, and
wherein the first-plate second-end side part is configured to be locked by the second-plate second-end side part.

20. The plate device of claim 19, wherein the second-plate second-end side part includes a second side hole, and
wherein the first-plate second-end side part includes a second locking boss configured to be inserted into the second side hole.
